(19) United States
(12) Patent Application Publication
(10) Pub. No.: US 2004/0145225 A1
(43) Pub. Date: Jul. 29, 2004

(54) Modular jeep seat

(76) Inventor: Roy H. Alter, Gardena, CA (US)

Correspondence Address: W. Edward Johansen, 11661 San Vicente Boulevard, Los Angeles, CA, 90049, US

(21) Appl. No.: 10/350,997

(22) Filed: Jan. 23, 2003

(51) Int. Cl. B60N 2/235

(52) U.S. Cl. 297/367; 297/362.12

(57) ABSTRACT

A modular seat for a jeep includes a base frame, a recliner assembly and a backrest. The base frame has a front member, a rear member and two side members. The front member has a hole in it or a mounting bracket that is attached to it. The recliner assembly is mechanically coupled to one of the two side members of the base frame. The backrest is mechanically coupled to the recliner assembly so that the backrest is able to recline relative to the base frame. A lever assembly is either disposed in the hole in the front member or coupled to the bracket. A cable mechanically couples the lever assembly to the recliner assembly so that the modular jeep seat can be installed on either the driver's side or the passenger's side of a jeep.

### BACKGROUND OF THE INVENTION

The present invention relates to automotive seats and more particularly to a modular seat that may be installed on either the driver's side or the passenger's side.

U.S. Pat. No. 4,630,866 teaches a reclining unit that controls the reclining angle of the backrest of a seat. The occupant of the seat can unlock the locking mechanism by operating a button that acts through a pull cable on the locking mechanism.

U.S. Pat. No. 4,887,864 teaches a reclining unit that includes a recliner assembly and a lever assembly that is remotely mounted. The lever assembly may either be integrated into the upholstery in the region of one of the bolsters or be separately mounted within the dashboard or a center console of the vehicle. A cable extends from the lever assembly to operate the recliner assembly. An occupant may accordingly adjust the backrest position relative the bench-seat without undue effort. The modularly arranged seat frameworks support custom upholstered seat cushions and are mountable in a variety of makes, models and years of automobiles.

U.S. Pat. No. 4,765,681 teaches a seat adjustable recliner hinge assembly that employs toothed sector, pivoted toothed pawl and retractable pivoted eccentric cam that is resiliently urged to pawl engaging sector retaining seat back-adjusted position. A remote lever actuated flexible cable release connection for the cam applies cable tension at an effective cam actuating radial moment arm relative to the cam pivot in a direction opposite to the resilient biasing.

U.S. Pat. No. 4,872,726 teaches a ratchet recliner that is used for automotive vehicle seats. The ratchet recliner has a remote hand lever release feature.

U.S. Pat. No. 4,223,947 teaches a ratchet recliner that includes a pivoted cam for locking a toothed pawl in engagement with a toothed sector for any adjusted position of the seat back hinge bracket, with a hand lever provided for direct actuation of the pivoted cam.

U.S. Pat. No. 6,267,443 teaches a reclining seat that has a backrest adjustable to any desired angle. The backrest is connected to the rear of the seat.

U.S. Pat. No. 4,653,807 teaches an adjustable seat assembly that includes a seat bottom and a seat back, a reclining mechanism for connecting the seat back to the seat bottom for the adjustment of the tilt of the seat back relative to the seat bottom.

Japanese Laid-open Utility Model Publication No. 57-48139, published on Mar. 17, 1982, discloses an adjustable seat assembly that is provided with reclining mechanism and slide mechanisms.

Japanese Laid-open Utility Model Publication No. 57-109936, published Jul. 7, 1982, discloses an adjustable seat assembly.

U.S. Pat. No. 5,803,529 teaches a removable vehicle top assembly for use with a Jeep-type vehicle for attaching a combination hard top and flexible soft-top cover. A first hard top cover is fastened over a forward passenger area of the vehicle.

U.S. Pat. No. 4,746,163 teaches a combination removable panel-convertible top system that includes a rear convertible frame section and a separately attachable section which extends between the rear section and an edge of the windshield to substantially overlay the forward seating area of the vehicle. While providing a convenient and useful convertible top assembly for a passenger-type vehicle, the device is not readily adaptable for use with other vehicle types, specifically Jeep design vehicles.

U.S. Pat. No. 4,850,634 teaches a folding top for cross-country vehicles which includes a number of interconnected tubular members which are selectively folded and unfolded to create a skeletal structure over which is attached a covering material. Its disadvantages include its relative complexity of design that increases the likelihood of a material failure over extended use. A further disadvantage of the folding structure is the inability to use the device with a Jeep-type vehicle that customarily utilizes roll bar protectors extending throughout the passenger and storage compartments of the vehicle, the existence of roll bars preventing the necessary range of motion. The standard Jeep vehicle includes forwardly directed passenger and rearwardly directed storage compartments. Two roll bars extend throughout the passenger and storage areas and provide protection the vehicle's occupants in the event of a rollover. Currently, two different Jeep top covers are available for use and include a soft top cover for warm weather driving conditions and a heavier hard top cover for winter driving. The disadvantages of owning two tops for use with the vehicle include the increased cost of owning more than one top, the need for storage of the unused top and the effort which must be expended in disengaging one of the tops and attaching the other.

U.S. Pat. No. 6,076,889 teaches a reclining car seat hinge for a chair.

The applicant hereby incorporates the above referenced patents into his application.

### SUMMARY OF INVENTION

The present invention is generally directed to a modular seat for a jeep. A modular seat includes a base frame, a recliner assembly and a backrest. The base frame has having a front member, a rear member and two side members. A seat cushion is mounted on the base frame. The recliner assembly is mechanically coupled to one of the two side members of the base frame. The backrest is mechanically coupled to the recliner assembly so that the backrest is able to recline relative to the base frame.

In a first aspect of the present invention the front member has either a hole in the front member or a mounting bracket that is attached to the front member. The modular jeep seat includes a lever assembly that is either disposed in the hole in the front member or coupled to the mounting bracket. A cable mechanically couples the lever assembly to the recliner assembly.

In a second aspect of the present invention the hole in the front member is located adjacent to the right side, left side or center of the modular jeep seat so that the modular jeep seat can be installed on either the driver's side or the passenger's side.

In a third aspect of the present invention either the hole in the front member or the mounting bracket is located adjacent to the left side of the occupant of the modular jeep seat.

In a fourth aspect of the present invention the hole in the front member is located in its middle.

Other aspects and many of the attendant advantages will be more readily appreciated as the same becomes better understood by reference to the following detailed description and considered in connection with the accompanying drawing in which like reference symbols designate like parts throughout the figures.

The features of the present invention which are believed to be novel are set forth with particularity in the appended claims.

### BRIEF DESCRIPTION OF THE DRAWINGS

FIG. 1 is a schematic drawing of a seat that fitted with a prior art recline unit for the backrest of the seat according to the teaching of U.S. Pat. No. 4,630,866.

FIG. 2 is a schematic drawing of a non-upholstered bucket seat that is constructed according to the teaching of U.S. Pat. No. 4,887,864.

FIG. 3 is a schematic drawing of a recliner assembly that is constructed according to the teaching of U.S. Pat. No. 4,765,681.

FIG. 4 is a partial perspective drawing of a modular jeep seat that includes a base frame, a backrest, a recliner assembly, a lever assembly and a cable of a first type according to the first embodiment.

FIG. 5 is a side view in partial cross-section of the cable of the first type and the lever assembly of the modular jeep seat of FIG. 4.

FIG. 6 is a side view in partial cross-section of a cable of a second type for use with recliner assembly and the lever assembly of the modular jeep seat of FIG. 4.

FIG. 7 is a partial perspective drawing of a modular jeep seat that includes a base frame, a backrest, a recliner assembly, a first pulling assembly and a cable of a second type according to the second embodiment.

FIG. 8 is a front view in partial cross-section of the cable of the second type and the first pulling assembly of the modular jeep seat of FIG. 7.

FIG. 9 is a front view in partial cross-section of a cable of a second type and a second pulling assembly for use in a modular jeep seat according to a third embodiment.

FIG. 10 is a partial perspective drawing of a modular jeep seat that includes a base frame, a backrest, a recliner assembly and a pushing assembly according to the fourth embodiment.

### DESCRIPTION OF THE PREFERRED EMBODIMENTS

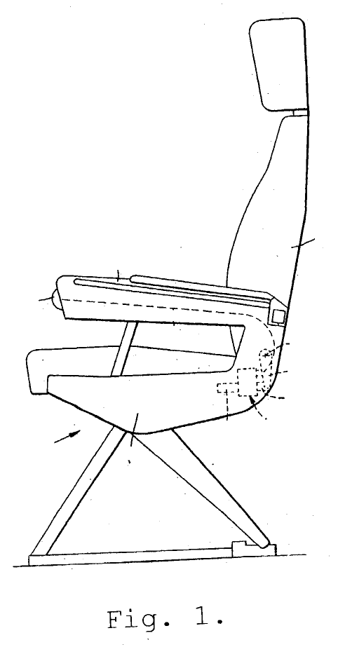

Referring to FIG. 1 U.S. Pat. No. 4,630,866 teaches a seat 11 that has a backrest 12 and a seat base 13. The backrest 12 is pivotally mounted at its lower part on the seat base 13 so that it can be swung about a transverse axis 14 between upright and reclined attitudes. A lever 15 that is fasten to the lower part of the backrest 12 extends downwardly from the pivot axis 14 and a seat recline unit 16 better shown is interposed as a strut between the lower end of the lever and the seat base 13. A flexible pull cable 37 has a conduit that is mounted in the body molding and secured thereto. A button 40 may be placed at a convenient position on the side of the seat base 13 or on an armrest 41. The button 40 is coupled by any suitable means to the core of the cable 37. The cable 37 is led from the recline unit 6 through the armrest. Depression of the button 40 by a seat occupant exerts a pulling action on the core.

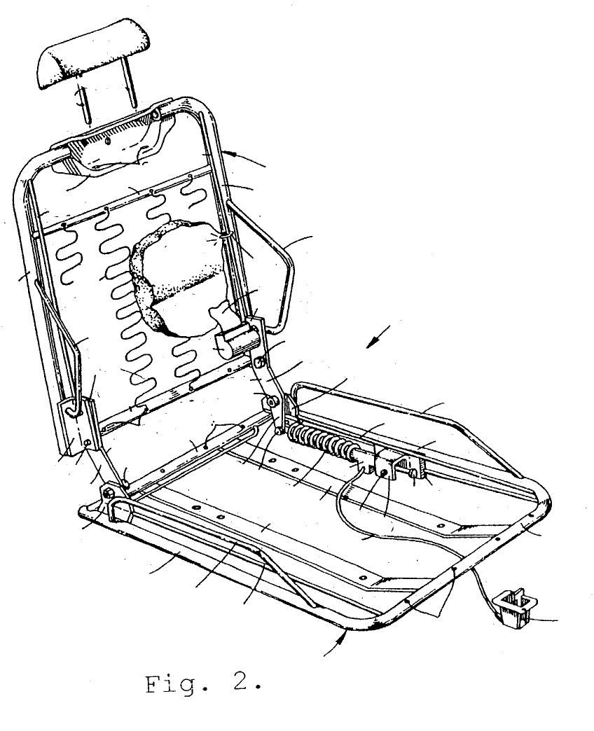

Referring to FIG. 2 U.S. Pat. No. 4,887,864 teaches a base frame 140 includes a backrest portion that reclines able by way of a remotely mounted lever assembly 119. The lever assembly 119 may be integrated into the upholstery in the region of one of the bolsters or be separately mounted within the dashboard or a center console of the vehicle. A cable 120 extends from the lever assembly 119 to operate a recliner assembly 158. The recliner assembly 158, including the cable 120 and the lever assembly 119 may be purchased.

Referring to FIG. 3 U.S. Pat. No. 4,765,681 teaches a recliner assembly 240 that includes an external lever 243. The external lever 243 is drivingly mounted on a squared end extension 244 of a release shaft 245. The external lever 243 is actuated by a cable connection 246 at the end of a cable extension 247 that projects from a reaction fitting 248 of a cable tube 249. The cable tube 249 is secured to a tab 250, pierced and formed to project from aperture 251 in side plate 252 of the seat bracket. The flexible cable release acts on a radial moment arm relative to the cam pivot and may be adapted to provide a release lever location wherever desired such as on a central armrest or any convenient accessible location on the seat.

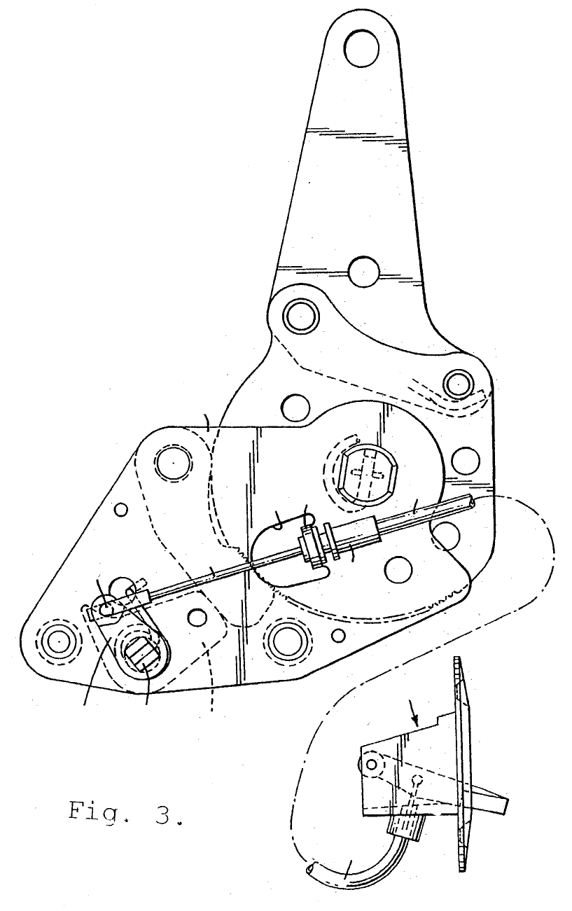

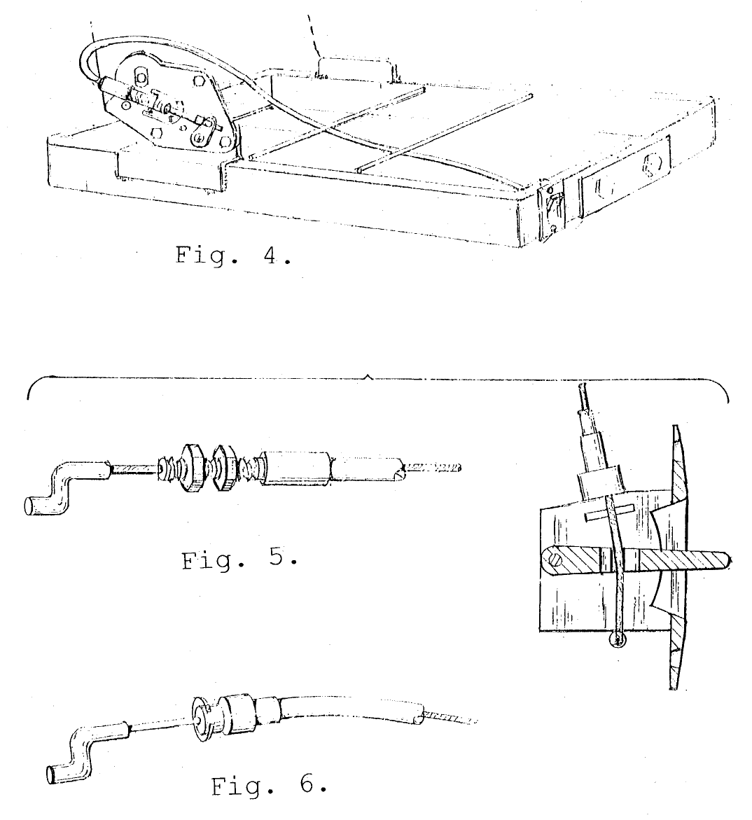

Referring to FIG. 4 in conjunction with FIG. 5 a modular seat 310 for a jeep includes a base frame 311, a recliner assembly 312 and a backrest 313. The base frame 311 has having a front member 314, a rear member 315 and two side members 316. A seat cushion may be mounted on the base frame 311. The recliner assembly 312 is mechanically coupled to one of the two side members 316 of the base frame 311. The backrest 313 is mechanically coupled to the recliner assembly 312 so that the backrest 313 is able to recline relative to the base frame 311. The front member 314 may have a hole 317. The modular jeep seat 310 also includes a lever assembly 320 that is disposed in the hole 317 in the front member 314. In an alternative embodiment a mounting bracket may be attached to the front member 314 and the lever assembly 320 is coupled to the mounting bracket. A cable 321 of first type mechanically couples the lever assembly 320 to the recliner assembly 312. Either the hole 317 in the front member 311 or the mounting bracket is located adjacent to the right side of the modular jeep seat 310 so that the modular jeep seat 310 can be installed on either the driver's side or the passenger's side. However, either the hole 317 or the mounting bracket may also be located either adjacent to the left side of the modular jeep seat or in its middle.

Referring to FIG. 6 a cable 322 of a second type mechanically couples the lever assembly 320 to the recliner assembly 312.

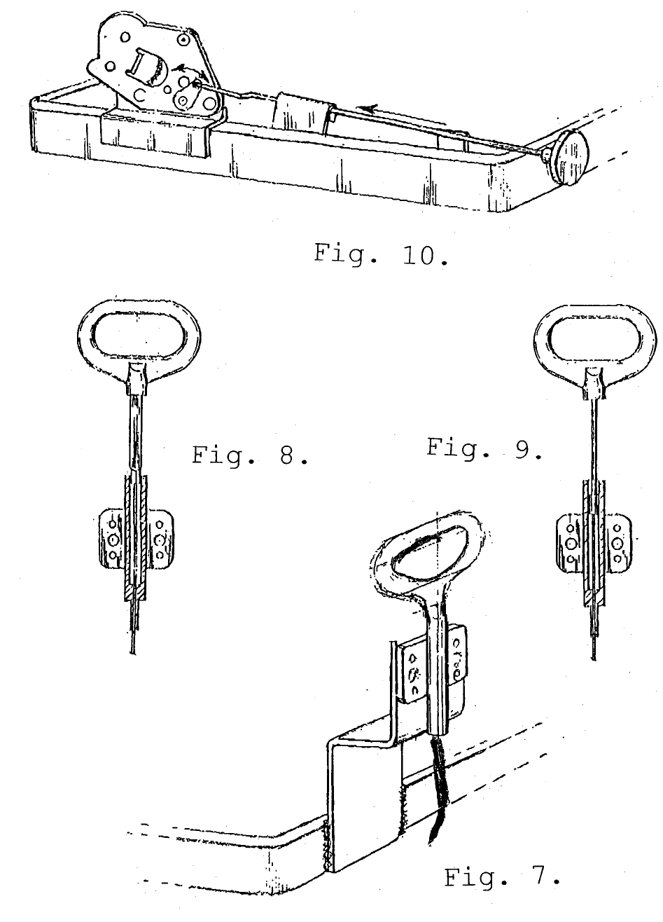

Referring to FIG. 7 in conjunction with FIG. 8 a modular jeep seat 410 includes a base frame 411, a backrest, a recliner assembly, a first pulling assembly 412 and a cable 413. The base frame 411 has a front member 414. A mounting bracket 415 is attached to the front member 414. A pulling assembly 420 is coupled to the mounting bracket 415. The pulling assembly 420 includes a handle 421 of a first type. A cable 422 mechanically couples the pulling assembly 420 to the recliner assembly. This embodiment is the easy to use ergometrically because when the occupant wants to lean back he pulls back the handle 421.

Referring to FIG. 9 a modular jeep seat 510 includes a base frame, a backrest, a recliner assembly, a second pulling assembly 512 and a cable 513. The base frame has a front member. A mounting bracket 415 is attached to the front member 414. A pulling assembly 520 is coupled to the mounting bracket. The pulling assembly 520 includes a handle 521 of a second type. A cable 522 mechanically couples the pulling assembly 520 to the recliner assembly.

Referring to FIG. 10 a modular jeep seat 610 includes a base frame 611, a backrest, a recliner assembly 612, a pushing assembly 613. The base frame includes a front member 614 and a side member 615. The pushing assembly 613 includes a push rod 616, a handle 617, a first mounting bracket 618 and a second mounting bracket 619. The first and second mounting brackets 617 and 618 are attached to the side member 615 and have holes that are serially aligned and parallel to the side member 615. The push rod 616 is inserted into the holes of the first and second mounting brackets 617 and 618 and is coupled to recliner assembly 612 at end and to the handle 617 at the other end.

From the foregoing it can be seen that a modular jeep seat has been described. It should be noted that the sketches are not drawn to scale and that distances of and between the figures are not to be considered significant.

Accordingly it is intended that the foregoing disclosure and showing made in the drawing shall be considered only as an illustration of the principle of the present invention.

What is claimed is:

1. A modular seat for a jeep, said modular seat comprising:
a. a base frame having a front member, a rear member and two side members wherein said front member has a hole;
b. a recliner assembly mechanically coupled to one of said two side members of said base frame;
c. a backrest mechanically coupled to said recliner assembly whereby said backrest is able to recline relative to said base frame; and
d. a lever assembly either disposed in said hole in said front member or coupled to said mounting bracket wherein said lever assembly is mechanically coupled to said recliner assembly by a cable so that said modular jeep seat can be installed on either the driver's side or the passenger's side of a jeep.
